(19) United States
(12) Patent Application Publication
(10) Pub. No.: US 2021/0033447 A1
(43) Pub. Date: Feb. 4, 2021

(54) SYSTEM AND METHOD FOR ASSESSING SENSORS' RELIABILITY

(71) Applicant: TaKaDu Ltd., Yehud (IL)

(72) Inventors: Asaf Aharoni, Ramat Hasharon (IL); Chaim Linhart, Hod Hasharon (IL)

(21) Appl. No.: 17/068,944

(22) Filed: Oct. 13, 2020

Related U.S. Application Data
(62) Division of application No. 14/816,852, filed on Aug. 3, 2015.
(60) Provisional application No. 62/032,657, filed on Aug. 4, 2014.

(51) Int. Cl. G01F 25/00; G01D 18/00

(52) U.S. Cl. CPC G01F 25/0007; G01D 18/00

(57) ABSTRACT

A method and a system are described for assessing reliability of a sensor by evaluating the sensor's reliability. The evaluation of the sensor's reliability is carried out by computing an estimate of the spread and/or the bias of measurements taken by the sensor

### RELATED APPLICATIONS

This application claims priority to U.S. Provisional Patent Application No. 62/032,657 filed Aug. 4, 2014, which is incorporated herein by reference.

This application is related to, and incorporates herein by reference, U.S. patent application Ser. No. 13/371,911, filed Feb. 13, 2011, titled “SYSTEM AND METHOD FOR ANALYZING GIS DATA TO IMPROVE OPERATION AND MONITORING OF WATER DISTRIBUTION NETWORKS,” now issued as U.S. Pat. No. 9,053,519; Ser. No. 13/313,261, filed Dec. 7, 2001, titled “SYSTEM AND METHOD FOR IDENTIFYING RELATED EVENTS IN A RESOURCE NETWORK MONITORING SYSTEM,” now issued as U.S. Pat. No. 8,341,106; Ser. No. 13/008,819, filed Jan. 18, 2011, titled “SYSTEM AND METHOD FOR IDENTIFYING LIKELY GEOGRAPHICAL LOCATIONS OF ANOMALIES IN A WATER UTILITY NETWORK,” now issued as U.S. Pat. No. 8,583,386; Ser. No. 12/717,944, filed Mar. 4, 2010, titled “SYSTEM AND METHOD FOR MONITORING RESOURCES IN A WATER UTILITY NETWORK,” now issued as U.S. Pat. No. 7,920,983; Ser. No. 13/040,435, filed Mar. 4, 2011, titled “SYSTEM AND METHOD FOR MONITORING RESOURCES IN A WATER UTILITY NETWORK”; Ser. No. 13/494,411, filed Jun. 12, 2012, titled “METHOD FOR LOCATING A LEAK IN A FLUID NETWORK”; Ser. No. 13/686,787, filed Nov. 27, 2012, titled “SYSTEM AND METHOD FOR IDENTIFYING RELATED EVENTS IN A RESOURCE NETWORK MONITORING SYSTEM”; Ser. No. 14/047,468, filed Oct. 7, 2013, titled “SYSTEM AND METHOD FOR IDENTIFYING LIKELY GEOGRAPHICAL LOCATIONS OF ANOMALIES IN A WATER UTILITY NETWORK”; and Ser. No. 14/702,879, filed May 4, 2015, titled “SYSTEM AND METHOD FOR ANALYZING GIS DATA TO IMPROVE OPERATION AND MONITORING OF WATER DISTRIBUTION NETWORKS.”

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention relates to the field of metering devices. More particularly, it relates to assessing the reliability of such meters/sensors.

### BACKGROUND

Water utilities use data measured by sensors, such as flow or pressure meters, for various goals. Unfortunately, a sensor is never 100% flawless, and its ability to measure true values may change over time, depending on its type and service period, the value of the flow/pressure (flow sensors can typically provide reasonably accurate measurements within a rather limited range of flows for which they are designed to operate accurately), external conditions, and additional factors. This drawback has been well recognized in the art, and many solutions have been proposed in the past. However, the prior art fails to adequately provide a solution to detect and estimate the bias and spread of sensors.

For example, U.S. Pat. No. 5,574,229A relates to conventional water meters, where there is not a proportion between the flow velocity of water flowing through the meter and the movement of the part that measures (i.e., the rotation of the turbine). This lack of proportionality may be a cause of error. U.S. Pat. No. 5,574,229A addresses this problem by utilizing an electronic automatic correction system, which compares the measurement data with a database stored in its memory, effects the necessary corrections and supplies the exact reading of the actual volume of water used.

Relatedly, European Patent No. 0921378A3 discusses a method for detecting malfunctioning of a mechanically based flow meter which comprises the steps of reading a primary flow signal of the flow meter several times per a mechanical cycle; analyzing the readings in order to find periodical, time-dependent variations; producing a current representation of the variations; and comparing the current representation with a corresponding normal representation which represents correctly operating meters of the same type, and detecting meaningful differences, if they exist.

Typically, sensor errors may be classified in two categories (bias and spread) as exemplified in FIG. 1 and discussed further herein. Bias, the antonym of accuracy, is a consistent one-sided error. For example, a sensor which consistently reports values that are, say, 10% above the actual values is said to have a (positive) bias of 10%. Spread, the antonym of precision, is a two-sided error (i.e. positive and negative). A sensor having a small spread of reported readings is a sensor that reports values that are very close to one another whenever it measures the same actual value. On the other hand, a sensor that reports readings having a large spread adds large errors (both positive and negative) to the measured results and is considered to be a sensor that reports less reliable values of the measurements being taken. As will be appreciated by those skilled in the art, the latter type of sensor (i.e. the one having large spread) typically adds a considerable amount of noise to the original signal, e.g. in a form of large random errors, both positive and negative.

The present disclosure seeks to provide a solution to detect and estimate the bias and spread of sensors.

### SUMMARY OF THE INVENTION

The disclosure may be summarized by referring to the appended claims.

It is an object of the disclosure to provide a novel method for use in determining which sensors, out of a plurality of sensors that have already been installed in a facility (e.g., a water, gas or electricity utility), measure inaccurate or imprecise values, and to what extent.

It is yet another object of the disclosure to provide a novel method for use in determining which sensor, or sensors, out of a plurality of installed sensors, needs to be examined, replaced, and/or re-calibrated.

It is yet another object of the disclosure to provide a novel method for use in determining which sensor (or sensors) out of a plurality of sensors installed in a utility, might be unsuitable to the extent its accuracy range is not compatible with the measurements' values which that sensor is actually expected to measure. For example, a water flow sensor might be oversized or undersized with respect to the rate of flows it needs to measure.

It is still another object of the disclosure to provide a novel method for use in monitoring a plurality of sensors and providing an alert in case of a change occurring in the measurements' accuracy and/or precision of one or more of the sensors.

It is another object of the disclosure to provide a novel method for use in determining whether a sensor (or sensors) out of a plurality of sensors is in compliance with the manufacturer's declared accuracy values, and to what extent.

Other objects of the invention will become apparent from the following description.

According to an embodiment of the disclosure, there is provided a method for assessing reliability of a sensor (e.g. one that is installed in a water utility facility), the method comprises evaluating the sensor's reliability by computing an estimate of the spread and/or the bias of measurements taken by the sensor.

A value of a physical measurement is the genuine value of a defined physical property and will be referred to hereinafter as an “actual value.”

A value outputted by a sensor as a result of a measurement taken by that sensor of a physical property will be referred to hereinafter as a “reported value” or “reported result”. Reliability of sensor is a function of the differences between the measured values and the reported values associated therewith.

According to another embodiment, the method provided further comprising assessing the sensor's reliability by utilizing additional information derived from additional measurements taken by that sensor, whether taken within a relatively small time interval from each other (e.g. within a time interval of few seconds) and/or whether they are taken at different times (e.g. during previous weeks). This additional information is then used in computing the spread and/or the bias in the reported results of the sensor and/or from a degree of fluctuations experienced in the sensor's reported results.

In accordance with another embodiment, the method further comprising assessing the sensor's reliability by utilizing additional information derived from sources being other than data retrieved by the sensor itself while taking measurements. The additional information according to this embodiment may be of the same type as the measurements taken by that sensor and/or of different types. In other words, if the sensor is configured to measure water flow, for instance, such additional information may be results of pressure measurements, temperature measurements, measurements of Chlorine concentration, pH measurements and the like. In addition or in the alternative, the additional information comprises prior knowledge which relates to the expected behavioral pattern of the actual values being measured by the sensor, such as smoothness, periodicity, bounds, etc.

By yet another embodiment, the additional information derived from sources other than the sensor itself, is derived from at least one member of a group that consists of: information on whether measurements' results obtained from at least one other sensor carrying out similar measurements exhibit essentially same behavior as results obtained by the sensor whose reliability is being inspected, information derived from at least one other sensor that can be correlated to results of the sensor being inspected, information derived from at least one other sensor, whose inter-relationship with the sensor being expected, is known, and information on possible threshold values associated with the sensor being inspected.

By yet another embodiment, assessing the spread in the sensor's reported values (i.e. assessing the sensor's precision) comprises the steps of: receiving a plurality of measurements' values as reported by the sensor; computing standard deviations of differences existing between data samples taken by said sensor within short time intervals during various hours of the day, and expressing the standard deviations as a function of the time intervals; interpolating the function that associates time intervals with respective standard deviation, (wherein the function may depend, for example, on time of the day), to obtain a momentary volatility of the sensor (i.e. a standard deviation that is obtained by interpolating reported values within an infinitely small time interval), thereby obtaining the sensor's inherent errors that do not stem from changes that occurred in the actual values of the physical property being measured by the sensor; and estimating the spread in values reported by the sensor, based on the sensor's inherent errors obtained.

According to still another embodiment, the method provided for assessing the spread and/or bias of a sensor that comprises the steps of: receiving a plurality of measurements' values as reported by the sensor; generating a plurality of expected values that correspond to the plurality of the reported values, wherein at least one of the expected values is computed based on reported values derived from at least one neighboring sensor and/or based on other reported values (e.g., at different time points) reported by the same sensor; comparing the plurality of reported values with the plurality of expected values; calculating distribution of differences that exist between the reported and expected values; estimating bias associated with the sensor by computing the mean of the calculated distribution (e.g. if the mean is a positive number equal to roughly 0.1 times the average of the reported values, then the sensor has a +10% bias); and/or estimating spread associated with the sensor by computing the standard deviation of the calculated distribution (the closer the standard deviation is to zero, the more precise the sensor is).

According to yet another embodiment, the method for computing the sensor's bias and/or spread is applied to a sub-set of the data, consisting of all reported values within a defined band (i.e. a range of values) and/or a defined time period (e.g. certain days, hours in the day, or a certain month).

According to another aspect of the disclosure, there is provided a system for monitoring a utility network that is capable of assessing reliability of at least one sensor selected from among a plurality of sensors associated with that network, the system comprising: a network information database for storing sensors' reported data representing a plurality of reported values (e.g. flow, pressure, turbidity, temperature, pH, etc.) of measurements taken by the plurality of sensors and at least one processor configured to evaluate a sensor's reliability by computing a spread and/or a bias of data obtained from reported values of measurements taken by the sensor.

According to another embodiment of this aspect, the at least one processor is further configured to assess the sensor's reliability by applying additional information derived from additional measurements taken by that sensor, whether taken within a relatively small time interval and/or whether they are taken at different times.

By yet another embodiment, the at least one processor is further configured to assess the sensor's reliability by applying additional information derived from sources being other than data retrieved by the sensor itself while taking measurements.

In accordance with another embodiment, the additional information is derived from sources being other than the sensor itself, is derived from at least one member of a group that consists of: information on whether measurements' results obtained from at least one other sensor carrying out similar measurements exhibit essentially same behavior as results obtained by the sensor whose reliability is being inspected, information derived from at least one other sensor that can be correlated to results of the sensor being inspected, information derived from at least one other sensor whose inter-relationship with the sensor being expected, is known, and information on possible threshold values associated with the sensor being inspected.

According to still another embodiment, the at least one processor is configured to: receive a plurality of measurements' values as reported by the sensor; compute standard deviations of differences existing between data samples taken by the sensor within short time intervals during various hours of the day, so that the standard deviations are expressed as a function of the time intervals; interpolate the function that associates time intervals with respective computed standard deviations to obtain a momentary volatility of the sensor, thereby obtaining the sensor's inherent errors that do not stem from changes that occurred in the actual values of the physical property being measured by the sensor; and estimate the spread in values reported by the sensor, based on the obtained sensor's inherent errors.

By yet another embodiment, the at least one processor is configured to: receive a plurality of measurements' values as reported by the sensor; generate a plurality of expected values that correspond to the plurality of the reported values, wherein at least one of the expected values is computed based on reported value derived from at least one neighboring sensor and/or based on other reported values, which were reported by the same sensor; compare the plurality of reported values with the plurality of expected values; calculate distribution of differences that exist between the reported and expected values; estimate bias associated with the sensor by computing a mean of the calculated distribution; and/or estimate spread associated with the sensor by computing standard deviation of the calculated distribution.

According to another embodiment, the system provided is configured to monitor the reliability of the at least one sensor, and to provide an alert upon detecting that the spread and/or bias of a sensor exceeds substantially a pre-defined threshold. One option to implement this embodiment is by setting the threshold value according to manufacturer's specifications or to the definition of the network's operator. The alerts may be associated with the sensor's overall reliability and/or to its reliability within a certain value band (e.g. range of reported values) and/or within a certain time-band (e.g. specific hours of the day, specific days or a defined period).

### BRIEF DESCRIPTION OF THE DRAWINGS

For a more complete understanding of the invention, reference is now made to the following detailed description taken in conjunction with the accompanying drawings wherein:

FIGS. 1A through 1D illustrate prior art presentations of sensor errors that are classified in two categories, accuracy vs. precision;

FIG. 2 illustrates a method for detecting inherent sensor errors according to one embodiment of the invention;

FIG. 3 illustrates a method for determining the spread and bias of a sensor according to one embodiment of the invention; and

FIG. 4 illustrates a system for detecting sensor errors according to one embodiment of the invention.

### DETAILED DESCRIPTION

In the following description, for the purposes of explanation, numerous specific details are set forth in order to provide a better understanding of the invention by way of examples. It should be apparent, however, that the invention may be practiced without these specific details.

In order to better understand the method provided by the present disclosure, it is instructive to elaborate on the terms used herein of “bias” and “spread.”

Assuming that the actual flow through a given water flow sensor at 3 AM is always 10 L/s and suppose the reported values of measurements made by this sensor at 3 AM during an entire month have been recorded. If the sensor is accurate, the average of these reported values will be very close to 10 L/s, whereas a biased sensor would have a mean reported value of, for example, 12 L/s (in case of a +20% bias) or 7 L/s (in case of a −30% bias). The spread score of the sensor, on the other hand, relates to the spread (standard deviation) of the reported values, not their average. If the sensor is precise, it is expected that all reported values of measurements taken by this sensor in case the flow remains constant, to be very close to each other, e.g., between 9.99 and 10.01 L/s (if the sensor is accurate) or between, for example, 11.98 and 12.02 (if it is biased). A sensor with a large spread, on the other hand, would give a larger range of reported values, e.g., between 9 to 11 L/s (if the sensor is accurate) or between 11 and 13 L/s (if it is biased). Of course, estimating the accuracy and the precision of a sensor is a much more complicated task under real-life conditions, since one does not know the actual flow values as there are many factors that might have influenced the actual flow value.

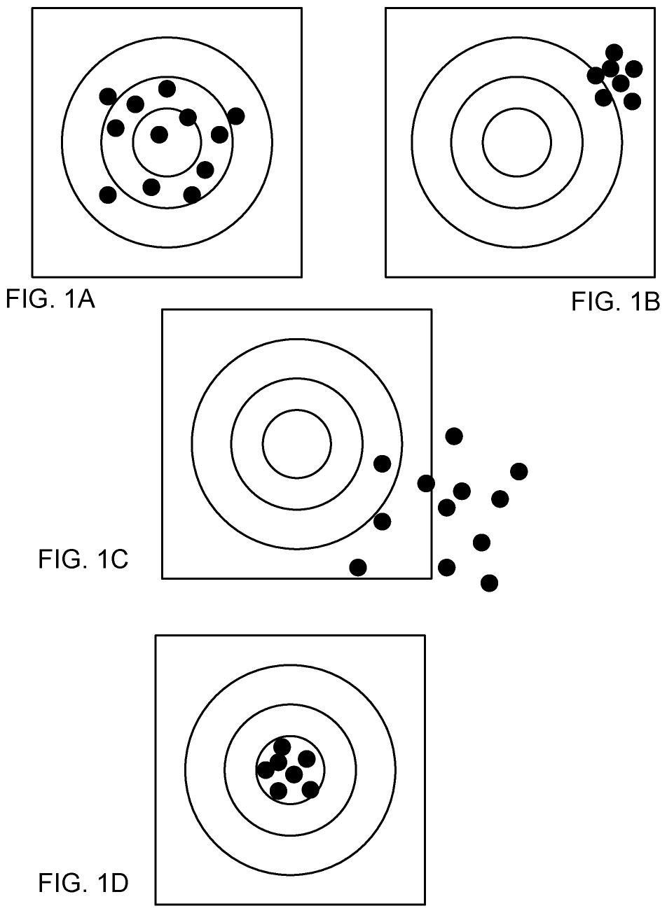

Unlike the theoretical example discussed supra, under real life conditions, one would not be able to assume that the flow at 3 AM is fixed (nor would the difference between the actual flow at 3:00 AM and the actual flow at 3:05 AM measured by the same sensor be known). A graphical depiction of the differences between bias (accuracy) and spread (precision) results is presented with respect to FIGS. 1A through 1D, wherein FIG. 1A illustrates a case where the results are accurate but not precise; FIG. 1B illustrates a case where the results are precise but not accurate; FIG. 1C illustrates a case where the results are not accurate and not precise; and FIG. 1D illustrates a case where the results are both accurate and precise.

A sensor that is configured to sporadically or periodically conduct a physical measurement in a water distribution network (or in any other applicable system), provides data that can be cross-correlated with additional information derived from sources being different from data retrieved by the sensor itself while taking measurements. That additional information may be derived from a variety of sources, including but not limited to, additional measurements taken by the same sensor (at different time-points, or of different types of measurements taken at the same time-points), measurements (of the same type and/or of other types) taken by other sensors, physical aspects of the measured substance, conditions under which the measurements were taken and the like. The additional information may be explicitly defined and/or automatically inferred by an additional inference algorithm. While in some cases, the additional information can be used to detect network anomalies in a way such as described for example in the Applicant's U.S. Pat. No. 7,920,983 which is hereby incorporated by reference, in other cases that additional information may be used to assess reliability of the measurements being taken, and sometimes even to quantify them.

Following are some examples demonstrating additional information that may be applied while establishing reliability of sensors being inspected:
1. A plot of a graph of the actual physical measurements taken as a function of time. Such a graph is typically expected to be a smooth graph, since actual changes in the actual measurements' values occur usually in a gradual manner;
2. Information on whether reported values of measurements made by another sensor or by a plurality of sensors carrying out similar measurements, are approximately the same as those of the sensor whose reliability is being inspected, or not. For example, comparing reported values of free chlorine concentration measurements taken by two sensors located next to each other;
3. Information derived from another sensor or sensors that can be correlated to the actual values that should have been reported by the sensor being inspected. For instance, reported values of measurements taken by two flow sensors which are installed in parallel to each other, where fluid dynamics may be used for predicting their inter-relationship, and thereby to enable predicting what should have been the results of the sensor being inspected, based on the results derived from the measurements of the other (in parallel) sensor;
4. Information derived from another sensor or sensors that can be correlated to the measurements of the sensor being inspected by knowing the inter-relationship between the sensors' layout. For example, when the sensor being inspected is part of a plurality of sensors measuring a water supply zone. Here are some examples demonstrating such cases:
   a. Flow sensors measuring the inlets/outlets of a supply zone may be used to calculate the total supply, which typically has statistical properties (e.g. based on daily and/or weekly periodicity), implying a relationship that exists between the various sensors, each measuring part of the supply;
   b. Pressure sensors located within the same pressure zone are typically highly correlated, and differences between their readings may further be estimated using hydraulic equations;
5. Information on threshold values associated with the sensor being inspected. For example, if very high pressure values obtained from a pressure sensor are correct, one should be able to observe multiple bursts in its vicinity. One other example is when readings are retrieved from a pressure sensor installed downstream of a pressure reducing valve, in which case they should typically remain nearly constant.

In view of the above, it should be understood that additional information may be used to further characterize the expected results of the measurements. For example, to define lower/upper values for the reported values that are retrieved from one or more of the sensors, in order to dictate a statistical model which the reported values should follow and/or define inter-connections between values of a plurality of measurements reported by one or several sensors, etc. This further characterization of the reported results, or rather the definition of boundaries within which the reported results are expected to be, may refer to the entire range of the measurements' values and/or parts thereof. Thus, the method provided by the invention may be used to identify sensors that are imprecise and/or inaccurate either under any operating conditions or only when measuring results within certain value ranges (bands). As the use of statistics is often relied upon as being part of determining the reliability of the sensors, the identification may be due to deviation from a statistical probability that is expected from a sensor that is accurate and/or precise.

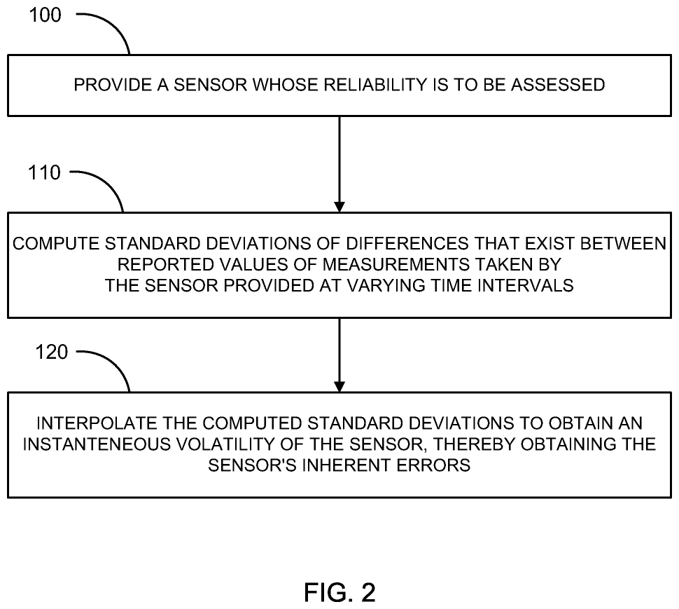

FIG. 2 illustrates a method for detecting inherent sensor errors according to one embodiment of the invention. In step 100, a sensor whose spread is to be assessed, is provided. Next, a standard deviation of the differences that exist between reported values for measurements obtained within short time intervals during various hours of the day at varying time differences, is calculated, step 110. These deviations are then interpolated, step 120, to obtain a momentary volatility, i.e., to obtain the sensor's inherent errors that do not result from changes that had occurred in the flow pattern.

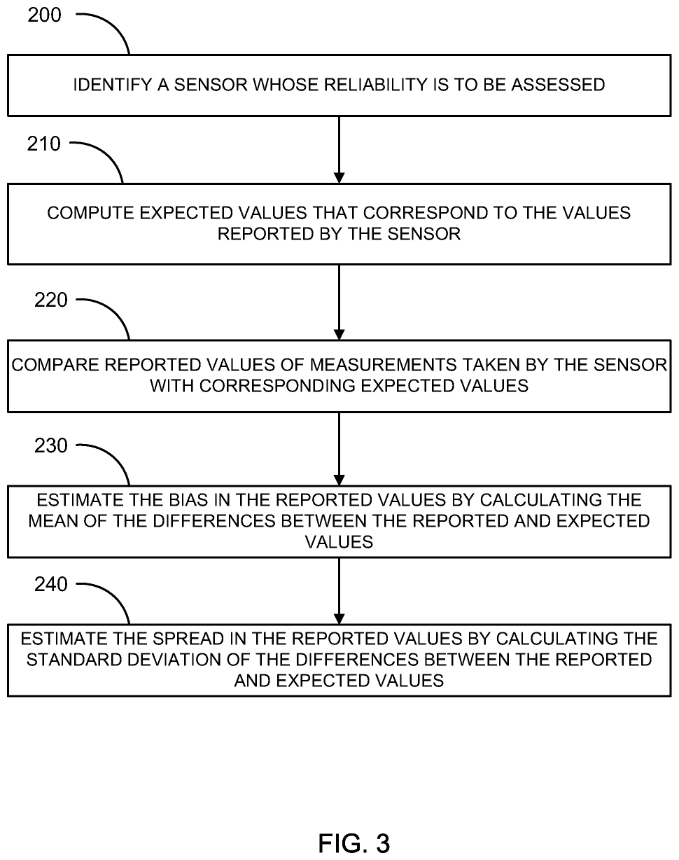

FIG. 3 illustrates a method for determining the spread and bias of a sensor according to one embodiment of the invention. In step 200, a sensor whose spread is to be assessed, is provided. Next, the expected values that correspond to the reported values of measurements taken by the sensor are computed, step 210, where each expected value is calculated based on reported data derived from neighboring points and/or other reported values derived from different measurements made by the same sensor and/or other sensors. Then, each data point representing a reported value for a measurement taken is compared with its respective expected value, step 220. Next, the bias of the reported values is estimated by calculating the mean of the differences between the observed and expected values, step 230. Likewise, the spread of the measurements' reported values is estimated, step 240, by calculating the standard deviation of the differences between the reported and expected values.

In a set of experiments conducted with water flow sensors, the standard deviation of the measurement errors was calculated, where each error is represented as a percent of the flow measured by the sensor at the corresponding time point. In addition to analyzing the behavior of the sensors' precision over time, it was also checked whether there are sensors for which the relative spread model does not hold, i.e., having errors that are not roughly a fixed fraction of the flow.

In most cases, the spread of a sensor remained substantially similar throughout the examined period and, additionally, the spread varied considerably between different sensors. The differences between the precision of sensors measuring similar flow rates may illustrate differences existing in the type or manufacturer of the sensors, their location within the network, installation conditions, service period, malfunctions, or other factors.

For most sensors, a linear correlation was observed between the spread and the respective flow values. However, in some cases the observed errors were substantially larger at low flow rates.

One possible explanation for the large spread at low flow values is that these sensors are oversized sensors. In other words, sensors often measure flow rates that are below the flows for which they were designed for by the manufacturer, or that currently their actual precision in the field is worse than what the manufacturer claims. At these low flows, the sensors are considerably less precise, and, perhaps, less accurate, too. However, there could be other factors that may explain this lack of precision. For instance, the flow via a certain sensor may actually be more stable at high rates (e.g., while a pump is operating, especially if this occurs at night) than during a period characterized by a low flow. Moreover, some of the sensors that were not identified as being oversized, might in fact be less precise at low flows. Still, since such low flow rates never, or rarely, pass through these sensors, these sensors are de-facto not oversized, at least not under normal operating conditions.

As was explained supra, a biased sensor is a sensor that usually reports higher (or lower) values than the actual (real) ones. For example, a sensor with a linear bias yields an average value of a×m, where m is the actual value, and a is a (positive) constant: if a>1, the reported values of the sensor measurements are higher than the real ones; whereas if a<1, the reported values of the measurements are lower than the real ones. When a=1 the results are accurate, indicating that the sensor is an unbiased sensor. Other bias models may also be utilized, e.g., a quadratic bias (a×m²) or an exponential bias (ma). In addition, bias models may also have multiple parameters, as opposed to the one parameter discussed above.

Using prior information that relates to statistical characteristics of the actual values, standard optimization techniques may be applied in order to establish model parameters that provide the best fit to the reported data obtained. Prior information on bias distribution may also be incorporated in this process. For example, a certain sensor model may tend to have a bias within a known range of measurements. Furthermore, as explained supra, some sensors may have a bias when the actual values they measure are within a specific range, or band, while they still operate with a high accuracy when the actual values are other than that specific range (i.e. when measuring actual values that are at different bands). For example, many models of water flow sensors tend to under-register when operating under low flow conditions. In some situations, the accuracy of the installed sensor complies with the manufacturer's specifications, but many of the reported values of the results recorded by this sensor fall within bands for which the sensor is known to be highly inaccurate. Such a sensor is in fact over-sized if it often measures values lower than those it was designed for, or under-sized if it often measures values higher than those it was designed for. In other situations, the conditions in which the sensor operates are according to the manufacturer's specifications, yet, the sensor is biased in some or in all bands, that is, it is substantially less accurate than it should have been.

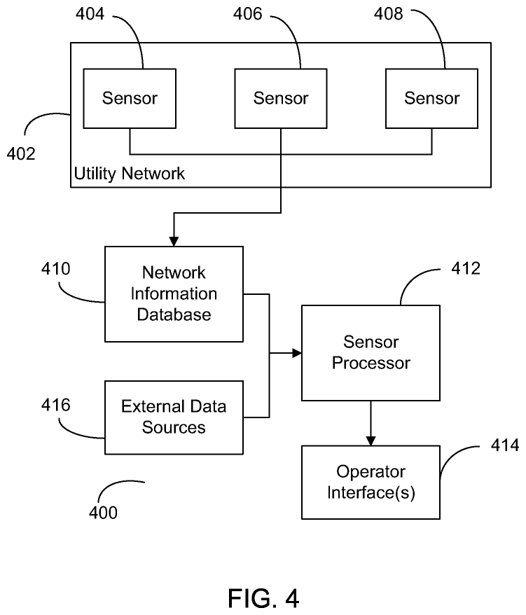

FIG. 4 illustrates a system 400 for detecting sensor errors according to one embodiment of the invention. As the embodiment of FIG. 4 illustrates, a utility network 402 comprises a plurality of sensors 404, 406, and 408 operable to capture and transmit data associated with the utility network. Exemplary data captured by sensors 404, 406, and 408 may comprise flow, pressure, turbidity, temperature, pH, etc.

Data captured by sensors may be transmitted to network information database 410. In one embodiment, network information database 410 may store sensor data representing a plurality of parameters measured by the sensors, as discussed supra. In alternative embodiments, data stored in network information database 410 may be preprocessed and formatted prior to subsequent transmissions.

Sensor processor 412 is communicatively coupled to network information database 410 as well as one or more external data sources 416. In one embodiment, external data may be of the same type as the measurements taken by that sensor and/or of different types. That is, if the sensor is configured to measure water flow, for instance, such additional information may be results of pressure measurements, temperature measurements, measurements of chlorine concentration, pH measurements and the like. Alternatively, or in conjunction with the foregoing, the external data may comprises prior knowledge which relates to the expected behavioral pattern of the actual values being measured by the sensor, such as smoothness, periodicity, bounds, etc. Sensor processor 412 is operative to process the data received from network information database 410 in accordance with the methods described herein. Additionally, sensor processor 412 is operative to transmit the results of processing to one or more operator interfaces 414. In one embodiment, operator interfaces 414 may include event tracking interfaces, alert interfaces, reports interfaces, and/or proprietary system interfaces.

### Example 1

In a first example, two sensors (M₁ and M₂) are installed in the system in such a way that they should record essentially the same values (e.g., two voltage sensors installed close to each other at the same power line), and a network operator may wish to determine whether sensor M₁ is biased. Furthermore, in this example a linear bias model (a×m) is assumed. Now, in this simple example, the parameter “a” can be found that best fits the ratio between the reported values of measurements taken by the two sensors, so that when the values recorded (reported) by M₁ are divided by “a”, one would be provided with the best fit to the values recorded by M₂. Obviously, the values recorded by the two sensors are not expected to be exactly the same, as sensing instruments always tend to have some inherent errors. The process referred to in this example may be carried out by using a linear regression technique.

### Example 2

For this example, sensor M₁ may be a water flow sensor installed at an inlet to a certain monitored supply zone Z. The total water supply to Z is the sum of all the flow ingres sing through its inlets, namely, M₁+M₂+ . . . +M_{N}, and it includes the amount of water consumed by customers located within the zone, as well as water losses due to leaks. Normally, the supply changes during the day (specifically, consumption is typically lowest at night), between days (weekend usage is usually different from weekdays consumption) and throughout the year (e.g., seasonality effects). However, in most cases the supply exhibits specific patterns, such as daily and weekly periodicities, which may be utilized to identify biased sensors. For example, a bias parameter “a” can be found that optimizes the weekly periodicity of the supply, as follows.

In this example, the weekly divergence is a score that measures the variation of the samples at each slice along the week (e.g., one slice includes all samples at 8:00 AM on Sundays, while another slice could include all samples at 9:00 AM on Sundays, etc.). The divergence could be the sum of the standard deviation in each slice, or some other statistical or heuristic measure. A low divergence score means that the supply at each slice remains stable along the weeks being examined. Thus, standard algorithms may be applied to find an optimal or near-optimal parameter “a” that minimizes the divergence score for M₁/a+M₂+ . . . +M_{N}.

As a special case, if the optimal value of “a” is close to −1, it can be determined that the sensor M₁ is flipped, i.e., it relates to the incoming flow as negative and outgoing flow as positive instead of relating to them the other way around. Another special case is when the value of “a” is close to a known ratio between relevant measurement units, i.e., the values of the measurements' results obtained from sensor M₁ are interpreted using the wrong units. In contrast to these special cases, if the sensor is indeed biased, the optimal value of “a” would typically be within some range around the value of 1, e.g., between 0.5 and 2.0, but not too close to the value of 1, as in this case it would mean that the sensor's results are unbiased.

### Example 3

In this example, a sensor M₁ is used to record samples at a relatively high rate (e.g., one sample every minute) and an operator wishes to check whether it is over-sized. It may be assumed that the signal measured by the sensor is known to be a smooth signal (i.e. with no sudden substantial changes) at this sampling rate. In other words, obtained results of consecutive samples are expected to follow some typical pattern, such as a linear model. In this case, the bias parameter “a” may be optimized so that consecutive samples best fit such a pattern. For instance, the score to minimize could be determined as the difference existing between each measured value and the expected value thereof, where the latter (i.e. the expected value) may be computed by using linear (or higher-order) regression from other samples obtained within a small time frame. A low score means that most samples lie very close to the interpolation line derived from the respective surrounding samples. In other words, the results of the sensor's measurements are smooth. Since an over-sized sensor is biased only when the measured values are below some cutoff value “c” (the sensor's lowest band), the above analysis should include only the relevant samples (those whose value is below c). If the cutoff “c” is not known in advance, standard techniques may be used to find a cutoff, for which the bias is highest (or nearly highest).

In a specific scenario, the sensor M₁ could totally fail to measure any value below the cutoff value of “c”, so that whenever the measured value is smaller than “c”, that sensor would yield the value of 0 as the measurement result (or some other fixed value). In this case, the optimal bias parameter “a” would have the value of 0, or a value very close to 0.

It should be noted, that although the some of the embodiments described herein provide a method for estimating the spread of a sensor, but do not specifically provide a method for independently identifying its bias, still, these two types of problems are quite often related to each other as when there is some fault (mechanical or other) in the sensor, the sensor measurements become more spread (less precise), and at the same time they become more biased (less accurate). Therefore, by identifying a sensor which has a relatively large spread in its measurements, that sensor may be suspected as being also a sensor having biased measurements.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The invention has been described using detailed descriptions of embodiments thereof that are provided by way of example and are not intended to limit the scope of the invention in any way. The described embodiments comprise different features, not all of which are required in all embodiments of the invention. Some embodiments of the invention utilize only some of the features or possible combinations of the features. For example, the description above relates to analysis performed on the entire set of data retrieved from the sensor's measurements, or parts thereof. Therefore, it should be understood that the invention also encompasses cases where certain time-frames are considered for the analysis, e.g. only at night; only when a pump is working; only when temperature is above a pre-defined value, etc. Also, it should be understood that the invention also encompasses cases where only certain bands (i.e. ranges of the reported values) are considered for the analysis, such as ranges that are defined by the utility, or taken from the sensor's specifications, etc.

Variations of embodiments of the invention that are described and embodiments of the invention comprising different combinations of features noted in the described embodiments will occur to persons of the art. The scope of the invention is limited only by the following claims.

What is claimed is:

1. A computer-implemented method for detecting the reliability of a sensor within a utility network by a sensor processor configured to detect abnormalities within the utility network, the method comprising:
receiving, by a sensor processor, data electronically transmitted from a plurality of sensors comprising one or more sensors positioned within a utility network and communicatively coupled to the sensor processor, the plurality of sensors including a first sensor;
determining, by the sensor processor, at least one expected value for at least one parameter of the first sensor based on reported data values from the plurality of sensors, the reported data values including measurements different from the at least one parameter of the first sensor;
comparing, by the sensor processor, the at least one expected value with at least one reported value associated with the first sensor;
determining, by the sensor processor, the reliability of the first sensor measuring at a given flow rate by: estimating the spread associated with the first sensor based on the results of the comparison between the at least one expected value with at least one reported value associated with the first sensor, identifying a manufacturer of the first sensor, and determining the given flow rate is not a flow rate that is operable for the first sensor based on the identified manufacturer; and
transmitting, by the sensor processor, results of the determined reliability to a system interface of the utility network.

2. A computer-implemented method for detecting the reliability of a sensor within a utility network by a sensor processor configured to detect abnormalities within the utility network, comprising:
receiving, by a sensor processor, data electronically transmitted from a plurality of sensors comprising one or more sensors positioned within a utility network and communicatively coupled to the sensor processor, the plurality of sensors including a first sensor;
determining, by the sensor processor, at least one expected value for at least one parameter of the first sensor based on reported data values from the plurality of sensors, the reported data values including measurements different from the at least one parameter of the first sensor;
comparing, by the sensor processor, the at least one expected value with at least one reported value associated with the first sensor;
determining, by the sensor processor, the reliability of the first sensor measuring within a range of measurements by: estimating the bias associated with the first sensor based on the results of the comparison between the at least one expected value with at least one reported value associated with the first sensor, identifying a manufacturer of the first sensor, and determining the range of measurements are inaccurate according to specifications of the manufacturer; and
transmitting, by the sensor processor, results of the determined reliability to a system interface of the utility network.
